(19) United States
(12) Patent Application Publication
(10) Pub. No.: US 2012/0050720 A1
(43) Pub. Date: Mar. 1, 2012

(54) SYSTEM FOR DIAGNOSING PATHOLOGICAL CHANGE OF LIPID IN BLOOD VESSELS USING NON-LINEAR OPTICAL MICROSCOPY

(75) Inventors: Se Hwa Kim, Daejeon (KR); Jae Yong Lee, Chungcheongbuk-do (KR); Eun Seong Lee, Daejeon (KR); Dae Won Moon, Daejeon (KR)

(73) Assignee: KOREA RESEARCH INSTITUTE OF STANDARDS AND SCIENCE, Daejeon (KR)

(21) Appl. No.: 13/320,014

(22) PCT Filed: May 11, 2009
(86) PCT No.: PCT/KR2009/002478

§ 371 Date: Nov. 10, 2011

(51) Int. Cl. G01J 3/44

(52) U.S. Cl. 356/51; 356/301

(57) ABSTRACT

Disclosed is a system for diagnosing the pathological change in lipids in blood vessels using coherent anti-strokes raman microscopy which can image lipids abnormally deposited on the deep intima of blood vessels and analyze the components of the imaged lipids, without labeling or destroying blood vessels, to diagnose minute pathological changes in the blood vessels, whereby the stage of progression of lipid-related diseases can be determined.

### TECHNICAL FIELD

The present invention relates to a diagnostic system for observing pathological changes in the lipids in blood vessel using non-linear optical microscopy. More particularly, the present invention relates to a system for diagnosing the pathological change in lipids in blood vessels using Coherent Anti-strokes Raman Scattering microscopy which can image lipids abnormally deposited on the blood vessel intima and analyze the components of the imaged lipids, without labeling or destroying blood vessels, to diagnose minute pathological changes in the blood vessels, whereby the stage of progression of lipid-related diseases can be determined.

### BACKGROUND ART

Lipids are associated with the various stages of arteriosclerosis progression. Lipid retention is regarded as an initial key event which has been implicated in the onset of arteriosclerosis. Although the so-called “response-to-retension” hypothesis has not been concretely verified, atherogenesis is induced by the accumulation of atherogenic lipoproteins in the intima. According to this model, once infiltrated into the intima, the lipoproteins combine with the extracellular matrix (ECM), chiefly with proteoglycans to create lipoprotein-proteoglycan complexes which induce atherogenic responses such as the recruitment of macrophages by secreted cytokines and lipid-laden foam cell differentiation. On the other hand, the content of lipids plays a critical role in determining the vulnerability of atheriosclerotic plaques in the late phase. Vulnerable plaques include the soft gruel phase of lipid-rich cores instead of hard collagen-rich cores. Indeed, several studies have reported that the lipid components of lesions are directly associated with the rupture of plaques and thrombosis. Advanced atheromatous cores contain cholesterols (both free and esterified types), phospholipids, triacylglycerols and fatty acids. In the atheromatous cores, the main component of cholesterol exist in crystallized forms with various appearances,such as plates, needles, and helices. In contrast to cellular membrane cholesterols, the crystalline cholesterols observed in advanced plaques are inert as extracellular lipids. Recently, Virmani et al. reported that ruptured plaques contain greater amounts of cholesterol clefts or crystals in necrotic cores than erosion or stable plaques from cross-sectioned coronary arteries, potentially indicating plaque vulnerability. Generally, the presence of atheriosclerotic lesions has been determined by evaluating narrowed arterial lumens rather than the morphology and chemical compositions of individual lesions mostly because there are no pertinent imaging modalities to perform the task. Conventionally, atherosclerosis has been diagnosed by systemic imaging in which luminal filling defects are read after the infusion of contrast media. Currently, because individual lesions are found to have heterogeneity, there is a need for imaging the vessel walls themselves. For the micropathological reading of vessel walls, current imaging techniques require tissue staining for micropathological reading, but this brings about damage to tissue. Further, the only images obtained are cross-sectional images from which it is very difficult to read pathological causes as existing in the tissue. In addition, there are no staining techniques which allow individual lipid components to be analyzed on images.

There are important criteria in diagnosing atherosclerosis. The earnest deposition of lipids is expedited by certain immune cells, e.g., macrophages. Activated macrophages contain excessive lipids and differentiate into foam cells. The appearance of foam cells is regarded as an important criterion for atherosclerosis. However, it is impossible for the current technology to visualize foam cells in tissues. Cholesterol exists as crystals in very advanced atherosclerosis. The amount of cholesterol crystals varies depending on the stage of advancement of atherosclerosis. It is also impossible for the current technology to image cholesterol crystals without destroying tissue.

Coherent Anti-stokes Raman Scattering (CARS) microcopy works by probing intrinsic molecular vibrations, which obviates the need to label target molecules and fix specimens. Thus, CARS microscopy has recently emerged as the most viable means for 3D chemical imaging of tissues. CARS microscopy has been used in the full-scale biological study of lipid metabolism in living organisms after direct evidence of the undesirable bias associated with fluorescence labeling techniques was demonstrated. Recently, a video-rate CARS microscopy system has been developed for imaging skin tissue in vivo. Because of the nonlinear nature of the CARS process, rapid scanning of the tight focal spot over the specimen permitted real-time acquisition of vibrational contrast images with 3D submicron resolution, which is not possible with conventional Raman microscopes. CARS microscopy is suitable for selective imaging of lipids because of the abundance of carbon-hydrogen (CH) bonds that exist in lipids as compared to the surrounding tissues. Lipids exhibit strong and distinct vibrational signatures in CARS spectra from 2700 to 3100 cm⁻¹. However, detailed chemical analysis of the lipid composition is beyond mere vibrational histology and is still limited in the currently available CARS imaging modalities.

### DISCLOSURE

### Technical Problem

It is therefore an object to provide a system for diagnosing a micropathological change in lipids, which performs en face microscopic imaging to chemical compositions of atherosclerotic lipids, without labeling or destroying blood vessel intima.

It is another object of the present invention to provide a method for diagnosing a pathological change in the lipids in blood vessels using the system.

### Technical Solution

In order to accomplish the above objects, the present invention provides a system for diagnosing a pathological change of lipids in blood vessel, comprising:

a near infrared pulse laser unit for selectively illuminating Stokes beams, pump beams and probe beams to generate a combined laser beam, said Stokes beams, said pump beams and said probe beams being different in wavelength from one another;

a platform in which a sample is mounted, said sample being illuminated with the combined laser beam generated by the near-IR pulse laser unit;

a wideband multiplex CARS microspectrometer unit for collecting CARS signals generated from the sample to detect a spectrum;

an en face CARS image mode detection unit for collecting CARS signal generated from the sample to reconstruct a three-dimensional image; and,

a dichroic mirror, located between the wideband multiplex CARS microspectrometer unit and the en face CARS image mode detection unit, for selectively transferring the CARS signal generated from the sample into each unit.

Also, the present invention provides a method for diagnosing non-destructive pathological changes in the lipids in blood vessels, comprising:

illuminating a Stoke beam and a pump beam on a sample to generate a CARS (coherent anti-Stokes Raman scattering) lipid signal and measuring wavelength and intensity of the CARS signal;

constructing the signal as a three-dimensional image; and

analyzing structures of lipids from the image.

Also, the present invention provides a method for diagnosing a non-destructive, pathological change of lipids in the blood vessels, comprising:

illuminating a probe beam on a sample to generate CARS (coherent anti-Stokes Raman scattering) lipid signal and measuring wavelength and intensity of the CARS signal;

detecting the signal in a spectral pattern; and

analyzing structures of lipids from the spectral image.

### Advantageous Effects

The system and the method in accordance with the present invention can selectively image lipids without damage attributable to staining or destruction, or labeling, and thus can diagnose the stage of progression of atherosclerosis.

### DESCRIPTION OF DRAWINGS

FIG. 1 is a schematic diagram showing a CARS microscopic measurement platform for lipid-selective 3D imaging and point spectral analysis.

FIG. 2 is an energy diagram of 3-color multiplex CARS with a wideband pump laser excitation. (a) Without the probe laser beam, a wideband integrated detection of the 2-color-excitated anti-Stokes signal generated by the multitude of lipid-related Raman resonances allows for fast lipid-window imaging. (b) Addition of the separate probe laser produces the multiplex CARS spectra that can be spectrally resolvable.

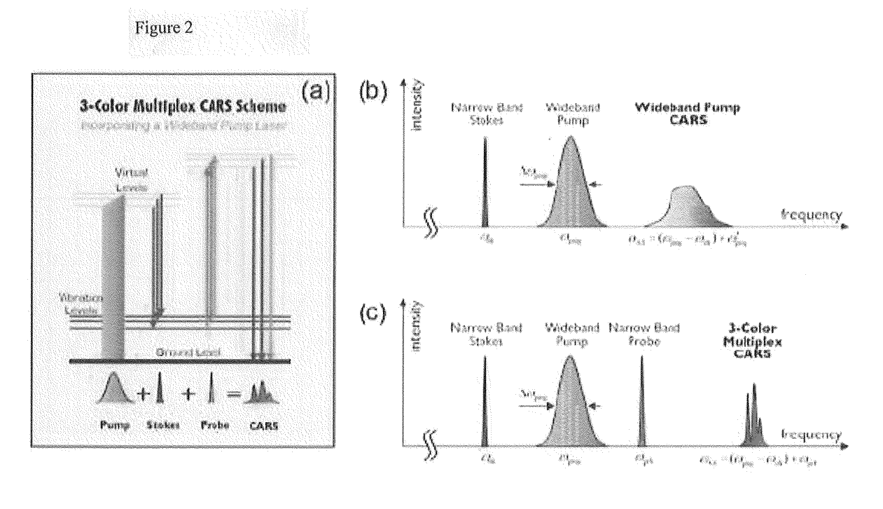

FIG. 3 shows label-free, lipid-selective CARS images of atherosclerotic plaques. (a) Three dimensional reconstruction of serial en face CARS imaging of atherosclerotic plaques. (b) 46-fold magnification of (a) images.

FIG. 4 shows label-free, lipid-selective CARS images of single atherosclerotic plaques. (a) 3D reconstruction of CARS images. (b) 2D representation, converted from the 3D imaging of atherosclerotic plaques, showing detailed lipid structures including foam cells in the surface layer, plate-shaped lipid crystals in the deep intima, and extracellular lipid deposits. The inserted indices indicate the CARS intensity associated with the abundance of CH bonding vibration and the white border defines a hemi-spherical shape of the atherosclerotic plaque in the 3D CARS image.

FIG. 5 shows CARS images of the human atherosclerotic carotid artery. (a) lipid-laden foam cells with a dark void corresponding to the nucleus in the surface area. (b) plate- and needle-shaped lipid crystals in the necrotic core.

FIG. 6 shows the stage of progression of atherosclerosis in ApoE^{-/-} mice as analyzed by CARS.

FIG. 7 shows the volumetric visualization of atherosclerotic plaque as analyzed by CARS according to the stage of progression of atherosclerosis: (a) initial stage, (b) intermediate stage and (c) advanced stage on the basis of the accumulation of lipids and the size of individual lipid droplets.

FIG. 8 shows on-site spectral analysis of the imaged CARS for atherosclerotic lipids according to the morphologies of atherosclerotic lipids: (a) intracellular, (b) extracellular, (c) plate-shaped, (d) needle-shaped, (e) non-arterial from the connective tissue and (f) non-lipids from the matrix. The inserted images represent typical shapes used for spectral analysis.

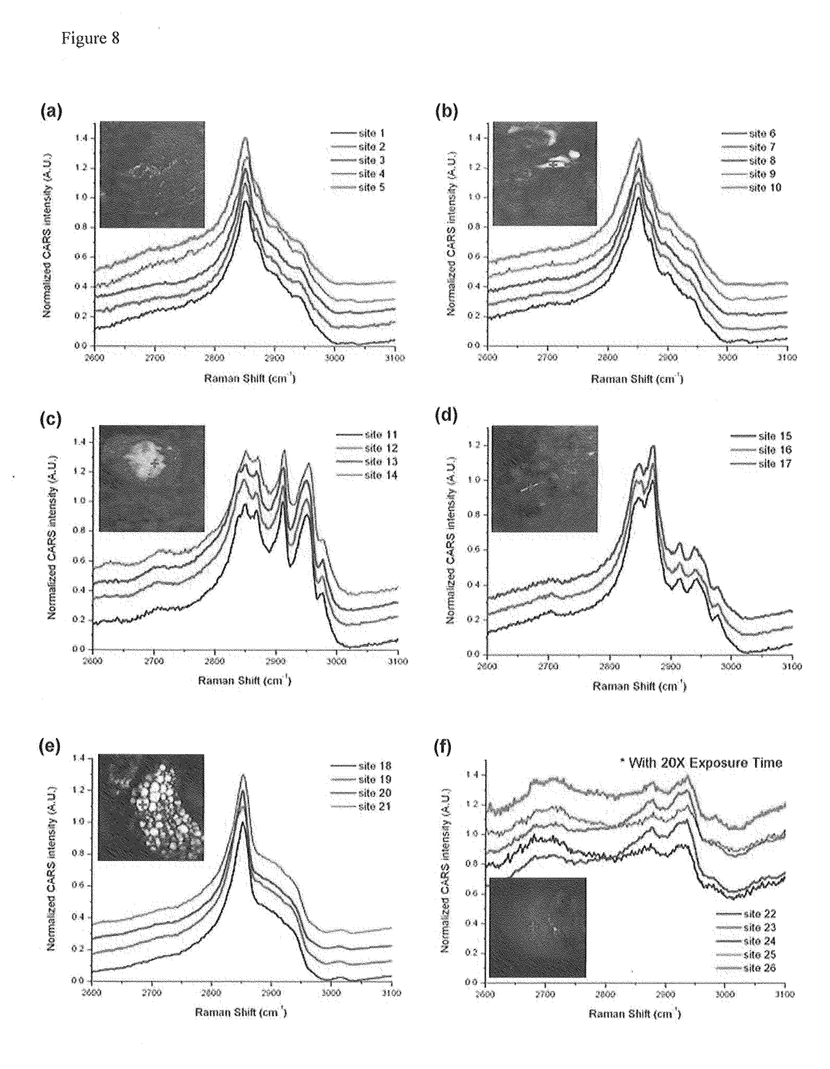

### BEST MODE

The present invention addresses a system for diagnosing a pathological change of lipids in blood vessels, comprising:

a near infrared pulse laser unit for selectively illuminating Stokes beams, pump beams and probe beams to generate a combined laser beam, said Stokes beams, said pump beams and said probe beams being different in wavelength from one another;

a platform in which a sample is mounted, said sample being illuminated with the combined laser beam generated by the near-IR pulse laser unit;

a wideband multiplex CARS microspectrometer unit for collecting CARS signals generated from the sample to detect a spectrum;

an en face CARS image mode detection unit for collecting CARS signal generated from the sample to reconstruct a three-dimensional image; and,

a dichroic mirror, located between the wideband multiplex CARS microspectrometer unit and the en face CARS image mode detection unit, for selectively transferring the CARS signal generated from the sample into each unit.

In an embodiment, the system of the present invention can perform lipid-selective 3D imaging and point-wise spectral analysis on the basis of C—H vibration in lipids, thereby constructing distinct images.

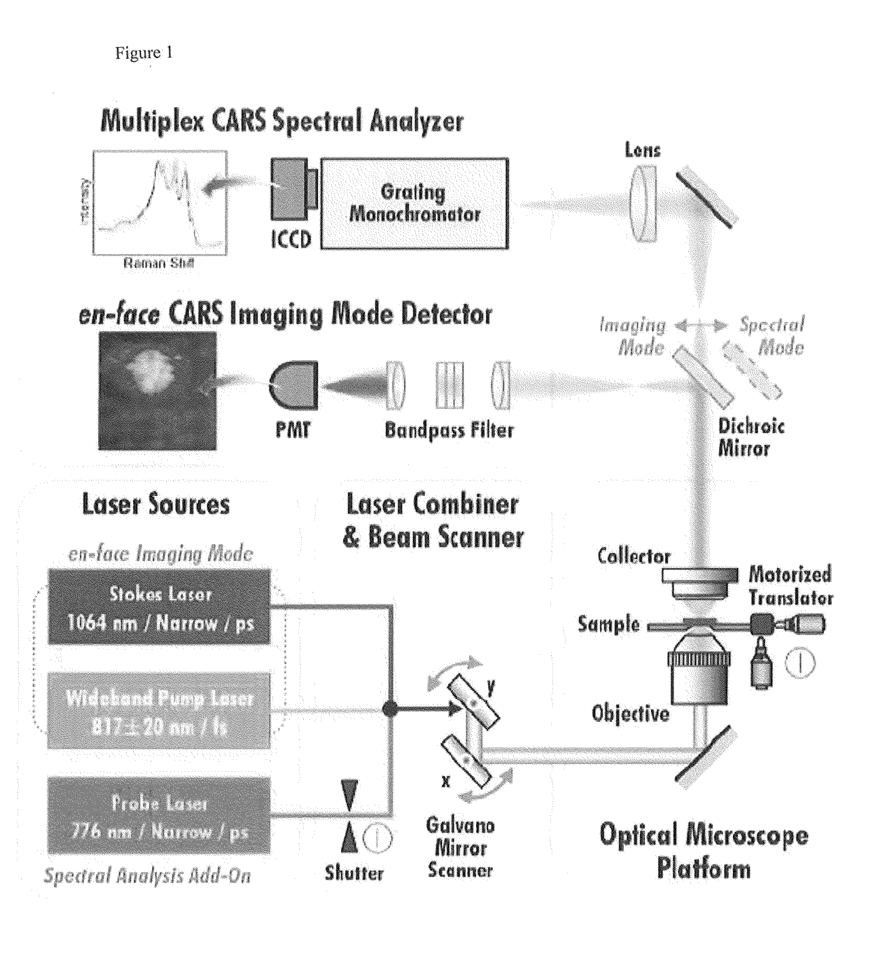

With reference to FIG. 1, the system for diagnosing a pathological change in the lipids in blood vessels is described in greater detail.

The near IR pulse laser unit can generate a combined laser beam by selective illuminating Stokes beams, pump beams and probe beams which are different in wavelength from one another. The generated beams vibrate the C—H bonds in lipids to construct 3D images of the lipids, with a concomitant assessment of related Raman shifts.

For 3D imaging of lipids, Stokes beams and pump beams may be illuminated on a sample while probe beams may be blocked with a mechanical shutter upon 3D imaging because they are used to conduct spectral analysis of the lipids.

Preferably, the CARS signal of a lipid, obtained with the excitation beam of the near IR pulse laser unit, ranges in bandwidth from 2700 to 3050 cm¹, which encompasses the entire CH stretching vibrations for 3D imaging.

In addition, the CARS signal is preferably collected at a rate of 1.0 s/frame, with a spatial resolution of 0.4 μm in a lateral plane and 1.3 μm along an axial (z) direction.

Further, the multiplex CARS microspectrometer unit functions to collect CARS signals generated from the sample and to detect spectra. An example is disclosed in Korean Patent Laid-Open Publication No. 2009-0024965, but is not limited thereto.

In the system of the present invention, the dichroic mirror is located between the wideband multiplex CARS microspectrometer unit and the en face CARS image mode detection unit and transfers the CARS signal generated from the same to each unit.

The dichroic mirror reflects wavelengths less than 1000 nm, but lets pass wavelengths of 1000 nm or greater.

After Stokes beams and pump beams are illuminated onto a sample, CARS lipid signals in the range of 645 to 675 nm are separated by a bandpass filter using the dichroic mirror and detected by the en face CARS imaging mode detection unit to provide a 3D image.

Further, for spectral analysis of lipids, the wideband multiplex CARS microphotometer unit is converted into a CARS measurement setup which is then illuminated with a probe beam for 50 to 150 ms with the laser-scanner adjusted in point-scan mode. As a result, a multiplex CARS signal is generated and passes through the grating monochromator to allow for spectral analysis. In this context, the probe beam preferably has a narrow band wavelength less than 3.5 cm⁻¹ from which anti-Stokes signals may appear in the range of 620˜640 nm.

The sample used in the system for diagnosing a pathological change of lipids in blood vessels according to the present invention is not treated with any fixative or staining agents. So long as it is excised from animals, any tissue may be used in the present invention. For example, an animal cardiovascular tissue may be used in the present invention.

The thickness of the sample which can be analyzed with 3D imaging using the system of the present invention is on the order of 100˜150 μm.

Further, the pathological change in the lipids in blood vessels which can be diagnosed by the system of the present invention may be an atherosclerotic plaque.

As analyzed with the 3D images of lipids obtained by the system of the present invention, lipid droplets (foam cells) were observed in the superficial intima of a sample in the initial stage of atherosclerosis while the number of lipid droplets significantly increases, extracellular lipid deposits were embedded in the deep intima, and some lipid droplets were deposited on the well-defined multiple layers of plate-shaped crystallized lipids in the deep intima. In the advanced stage, the necrotic core had enlarged and was projected toward the lumen, crystallized lipid layers were predominantly imaged, and fibrous enlargement was observed.

The present invention also addresses a method for diagnosing non-destructive pathological changes in the lipids in blood vessels, comprising:

illuminating a Stoke beam and a pump beam on a sample to generate a CARS (coherent anti-Stokes Raman scattering) lipid signal and measuring wavelength and intensity of the CARS signal;

constructing the signal as a three-dimensional image; and

analyzing structures of lipids from the image.

The sample used in the system for diagnosing a pathological change in the lipids in blood vessels according to the present invention is not treated with any fixative or staining agents. So long as it is excised from animals, any tissue may be used in the present invention. For example, an animal cardiovascular tissue may be used in the present invention.

For 3D imaging, the signal is collected through a bandpass filter and detected by the en face CARS imaging mode detection unit.

In the 3D images, lipids in various structures are observed, for example, lipid droplets, plate- and needle-shapes crystals. When imaging animal atherosclerotic blood vessels, lipid structures are found to exist in various forms characteristic of the stage of progression of atherosclerosis. Further, volumes and sizes of lipids can also be analyzed. Accordingly, the stage of progression of atherosclerosis can be determined with the 3D images.

Also, the present invention addresses a method for diagnosing a non-destructive, pathological change of lipids in the blood vessels, comprising:

illuminating a probe beam on a sample to generate CARS (coherent anti-Stokes Raman scattering) lipid signal and measuring wavelength and intensity of the CARS signal;

detecting the signal in a spectral pattern; and

analyzing structures of lipids from the spectral image.

The sample used in the system for diagnosing pathological change of lipids in blood vessels according to the present invention is not treated with any fixative or staining agents. So long as it is excised from animals, any tissue may be used in the present invention. For example, an animal cardiovascular tissue may be used in the present invention.

The signal passes through a grating monochromator and can be detected in a spectral pattern by the wideband multiplex CARS microspectrometer unit.

In the spectrum, both extracellular lipid droplets in the ECM and intracellular lipid droplets from lipid-laden foam cells exhibit one main peak (2845 cm⁻¹). The plate-shaped lipid crystal exhibits four extra peaks at 2880, 2905, 2920 and 2950 cm⁻¹ on the CARS spectrum. The needle-shaped crystallized lipids showed weaker peaks at 2905, 2920 and 2950 cm⁻¹. These peaks reflected pathological changes in the lipids.

Therefore, the chemical profiles of lipids can be applied to the determination of the stage of progression of atherosclerosis.

A better understanding of the present invention may be obtained through the following examples which are set forth to illustrate, but are not to be construed as limiting the present invention.

### Mode for Invention

### EXAMPLE 1

### Setup of CARS Imaging Platform

For lipid-selective 3-D microscopic imaging and point-wise spectral analysis of cardiovascular tissues having atherosclerotic lesions, a wideband multiplex CARS microspectrometer and laser-scanning CARS microscope were concurrently set on the same platform.

As shown in FIG. 1, the laser-scanning CARS microscope consists of a modified commercial laser-scanning confocal microscope (IX81/FV300; Olympus, Japan) combined with a grating monochromator (Triax320; Horiba Jobin Yvon) and a near-infrared (near-IR) pulsed laser system generating three-color synchronized CARS excitation beams. A 1064-nm mode-locked neodymium vanadate (Nd:YVO₄)laser (picoTrain; High Q Laser Production GmbH, Hohenems, Austria) delivering a 10-W average power 7-ps pulse train at a repetition rate of 76 MHz was used to generate the CARS Stokes beam by splitting off 10% of its output power and guiding it into the microscope through a pulse delay line. The main portion (9 W) was utilized for synchronously pumping an intracavity doubled optical parametric oscillator (Levante; APE GmbH, Berlin, Germany) to generate the 1.3-W CARS probe beam in a 6-ps, 76-MHz pulse train at a 776.7-nm wavelength. The multiplex CARS pump beam centered at a wavelength of 817 nm was produced from a wideband femtosecond mode-locked titanium-sapphire laser (Micra-10; Coherent, Inc., Santa Clara, Calif.) providing 800-mW average power and a pulse bandwidth adjusted to about 35 nm, the output pulse train of which was actively synchronized with that of the 1064-nm CARS Stokes beam to maintain the common repetition rate at 76 MHz and same pulse timing using a cavity stabilization feedback servo (SynchroLock-AP; Coherent, Inc.). The beam diameter and divergence of each laser were adjusted by a telescope beam expander placed in each beam path to match one another. The three CARS excitation beams were then collinearly overlapped in space using two beam-combining optics in series: the pump and probe beams were combined at a 50:50 broadband beamsplitter (CVI Melles Griot, Albuquerque, N. Mex.) and the Stokes beam was combined with them with a dichroic mirror (Chroma Technologies Corp., Rockingham, Vt.) having high reflectivity (>99%) for near-IR wavelengths in the range of 730-960 nm and high transmittance (>90%) for the Stokes beam at 1064 nm. The combined laser beams were delivered to a 1.2NA 60□ water-immersion microscope objective (UPlanSApo UIS2; Olympus) through the two-axis beam scanning unit (FV300) consisting of a pair of galvanometer-mounted gold mirrors with a reflectivity of about 95% for wavelengths longer than 600 nm. To avoid laser-induced damage of the tissue sample, the average power of the combined laser beams illuminating the sample was limited to less than 40 mW in total by attenuating the power of each laser output with neutral density filters.

In summary, label-free, lipid-selective chemical imaging is implemented with a CARS platform covering the Raman shift from 2700 to 3050 cm⁻¹ in which the bandwidth of the beams used is expanded to allow multiplex access to the entire CR stretching vibration in the range of 2700-3050 cm⁻¹, so that atherosclerotic lipids can be visualized and chemically analyzed. Next, The CARS microscopy setup could acquire two dimensional (2D) en-face images having a maximum field of view of 250×250 μm² with a spatial resolution of 0.4 μm in the lateral (x-y) plane and 1.3 μm along the axial (z) direction, and obtain image slices at a frame rate of 1.0 s/frame, which is improved compared to typical Raman microscopes for label-free bio-imaging. Finally, the CARS microscope can be readily converted to a wideband multiplex CARS setup used for the spectral analysis of atherosclerotic lipids. After lipid-selective 3D imaging, sites suitable for CARS spectral analysis are selected and exposed for 50˜150 ms before analysis.

(Sample Preparation)

For use as samples, Carotid endarterectomy specimens were obtained from patients with carotid artery stenosis (aged 63-81 yr) who underwent surgery at Samsung Medical Center (SMC). The specimens were immediately immersed in phosphate-buffered saline (PBS) and delivered for CARS analysis. Two internal mammary artery specimens were also obtained from coronary artery bypass graft patients for use as reference. This study was approved by the Institutional Review Committee at SMC, complying with the Declaration of Helsinki guidelines, and informed consent was obtained from all subjects (IRB 2006-02-011).

(Animal Test)

Apolipoprotein E knock-out (ApoE^{-/-}) mice were purchased from the Jackson Laboratory (Bar Harbor, Me.) and adapted for one week at the Samsung Biomedical Research Institute under specific pathogen-free conditions. Eight-week-old male ApoE^{-/-} mice were fed on a 0.15% high-fat high-cholesterol (HFHC) diet (n=22) for 2-20 weeks (CRF-1; Research Diets, Inc., New Brunswick, N.J.). Mice fed normal chow were used as reference. Every other week after 2 weeks, 4-6 mice were sacrificed with CO₂ inhalation. The heart and aorta were perfused with PBS for 10 min and then promptly removed for CARS imaging. All animal studies conformed with the Institutional Animal Care and Use Committee of Samsung Biomedical Research Institute.

(Sample Preparation for Ex Vivo CARS Imaging)

After harvesting the heart and aortas, the samples were prepared for CARS imaging. The connective tissue of the aorta was carefully removed and the aorta was stored in cold PBS to allow analysis of its lipid chemical profile by CARS. The aortas were incised longitudinally from the ascending aorta to the thoracic descending aorta and dissected into four segments for further assessment as follows: 1) the aorta segment containing the lesser curvature of the aortic arch, 2) the aorta segment containing the innominate artery, 3) the aorta segment containing the left common carotid and left subclavian arteries, and 4) the segment of the thoracic descending aorta. Prepared segments were mounted lumen-side down on a coverslip using PBS with no chemical mounting solution or fixatives for subsequent CARS study.

(Statistics)

Image analysis was performed using Image-Pro software (Media Cybernetics, Inc., Bethesda, Md.). All imaging analyses of optical density measurements were conducted in triplicate to minimize the deviations of each case. All probabilities were compared using Student's t-test. All p-values less than 0.05 were considered statistically significant.

### EXPERIMENTAL EXAMPLE 1

### En Face CARS 3D Imaging of Atherosclerotic Lesion

En face chemical imaging of mouse and human atherosclerotic plaques was performed using the CARS microscope of Example 1. After whole aortas were harvested from atherosclerotic ApoE^{-/-} mice (n=28), the lesser curvature of the aortic arch and the carotid artery was longitudinally incised and imaged by CARS, without the use of fixatives.

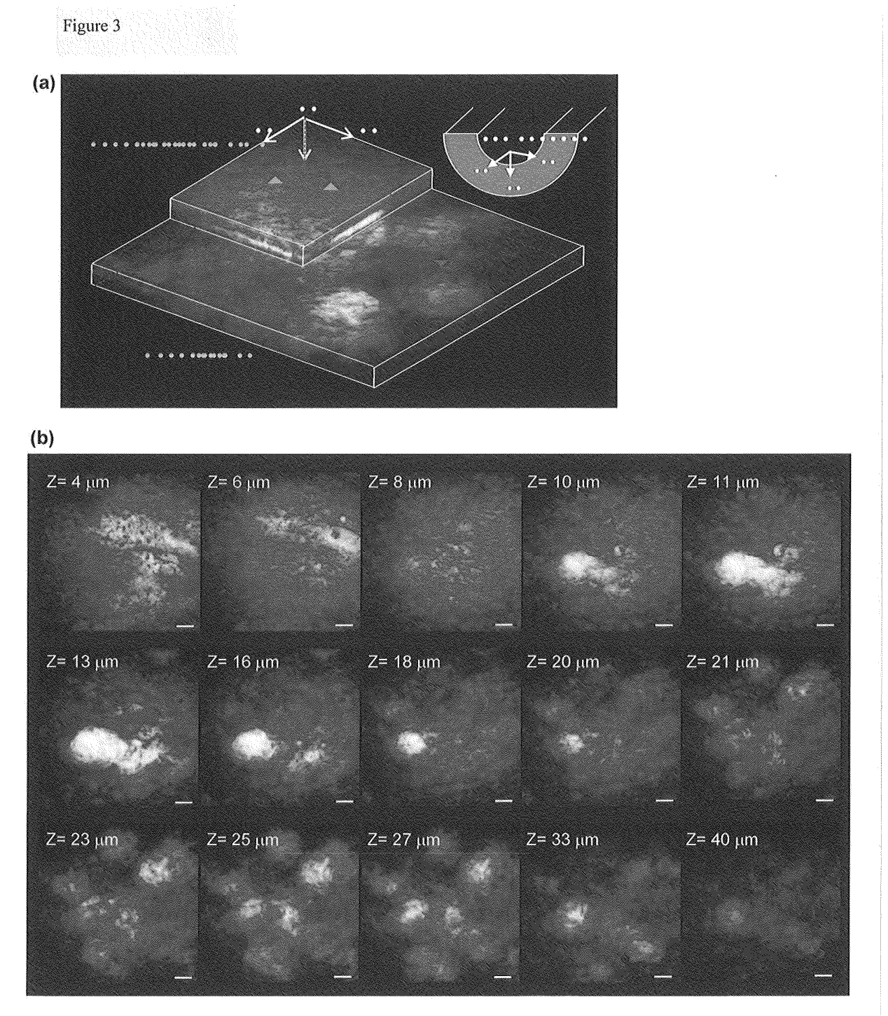

FIG. 3 shows the 3D reconstructed CARS image slice, representing atherosclerotic plaques ranging from the lumen side to the deep intima. In the CARS image, bright spots show a high concentration of lipids with CH vibrations characteristic of 2700 to 3050 cm⁻¹, demonstrating typical 3D microscopic traits of atherosclerotic lipids depending on the depth of lesions. In the superficial layers (5 to 10 μm in depth from the lumen), foam cells containing intracellular lipid droplets were clearly imaged, whereas lipid crystals were observed usually in the deep intima region (>25 μm in depth), without deformation of their volumetric structures. In atherosclerotic plaques, lipids can be classified into 1) intracellular droplets, 2) extracellular deposits, 3) multilayer crystal plates, and 4) needle-shaped lipid crystals. Foam cells were imaged only in the superficial intima (3-4 μm). On the other hand, the multilayer plate-shaped lipids were observed in the deep intima well separated from the foam cells. Some of the plate-shaped lipid crystals are distributed parallel to or at an oblique angle to the intima surface over a wide area. The needle-shaped lipid crystals, together with plate-shaped lipid crystals, were embedded in the deep intima.

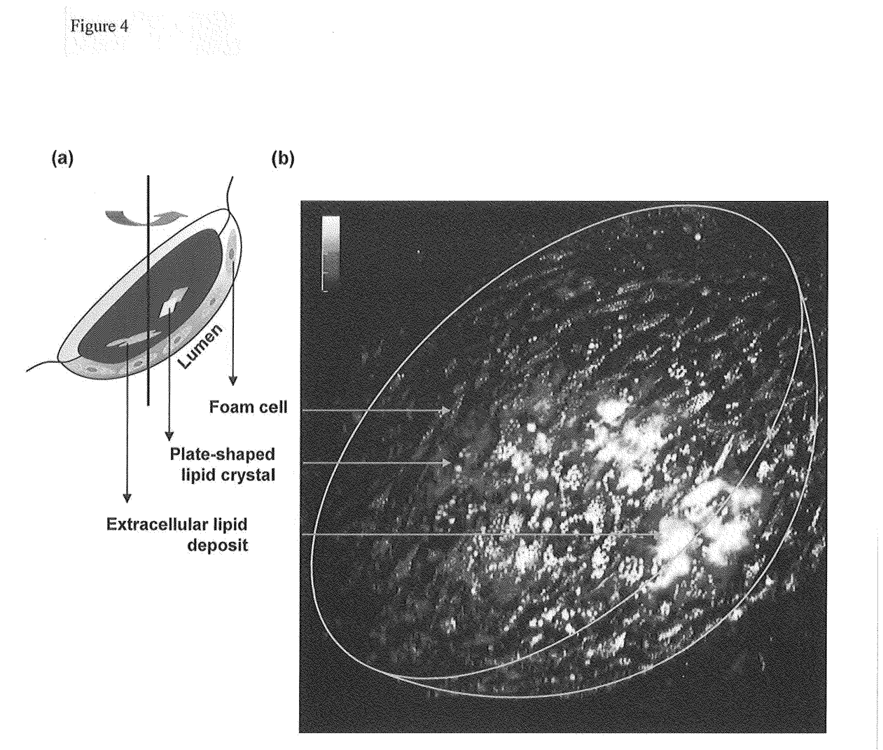

As can be seen in the semi-spherical 3D CARS image of a single atherosclerotic plaque of FIG. 4, micro-anatomical components including lipid droplets (foam cells), superficial and extracellular lipid deposits, and cholesterol-rich extended cells distributed in the deep intima were observed.

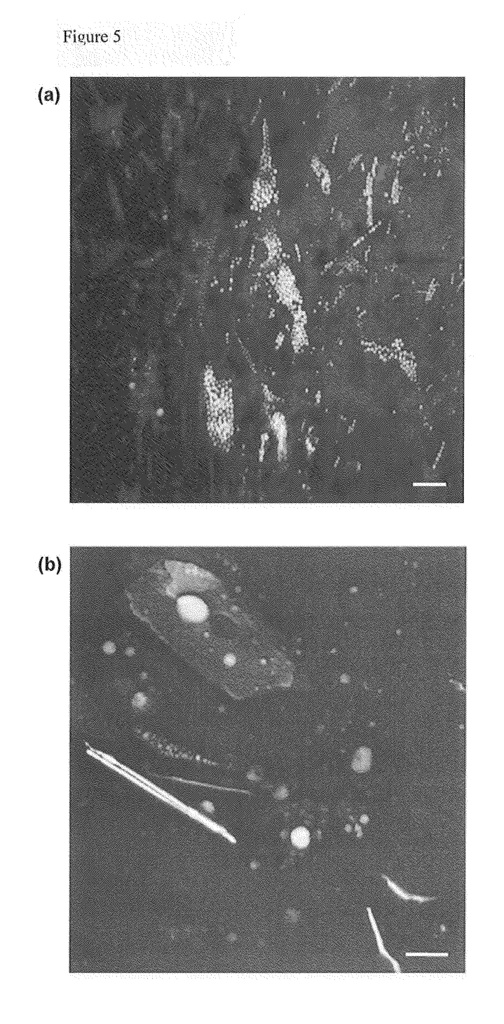

To investigate the medical applicability thereof, CARS microscopy was applied to the human atherosclerotic carotid artery using the same imaging protocol (FIG. 5). Foam cells were successfully imaged at a site 40 μm deep from the surface, and lipid crystals were observed in the deep intima (>80 μm) as in mice. The possible maximal depth for CARS imaging in human tissue was on the order of 100˜150 μm.

### EXPERIMENTAL EXAMPLE 2

### Assessment of Atherosclerosis Progression by CARS Imaging

To assess the progression of atherosclerosis using the CARS imaging platform of Example 1, various levels of atherosclerotic plaques were obtained from ApoE^{-/-} mice (n=28) fed with a high-fat diet for 2 to 20 weeks. As a control, ApoE−/− mice fed with a normal chow diet were assessed at the same time points. Every week, serial en face CARS imaging was performed in mouse aortas. The progression of atherosclerosis was analyzed using CARS images taken for the vertical infiltration of lipids across the aortic wall and the morphological change of lipid structures.

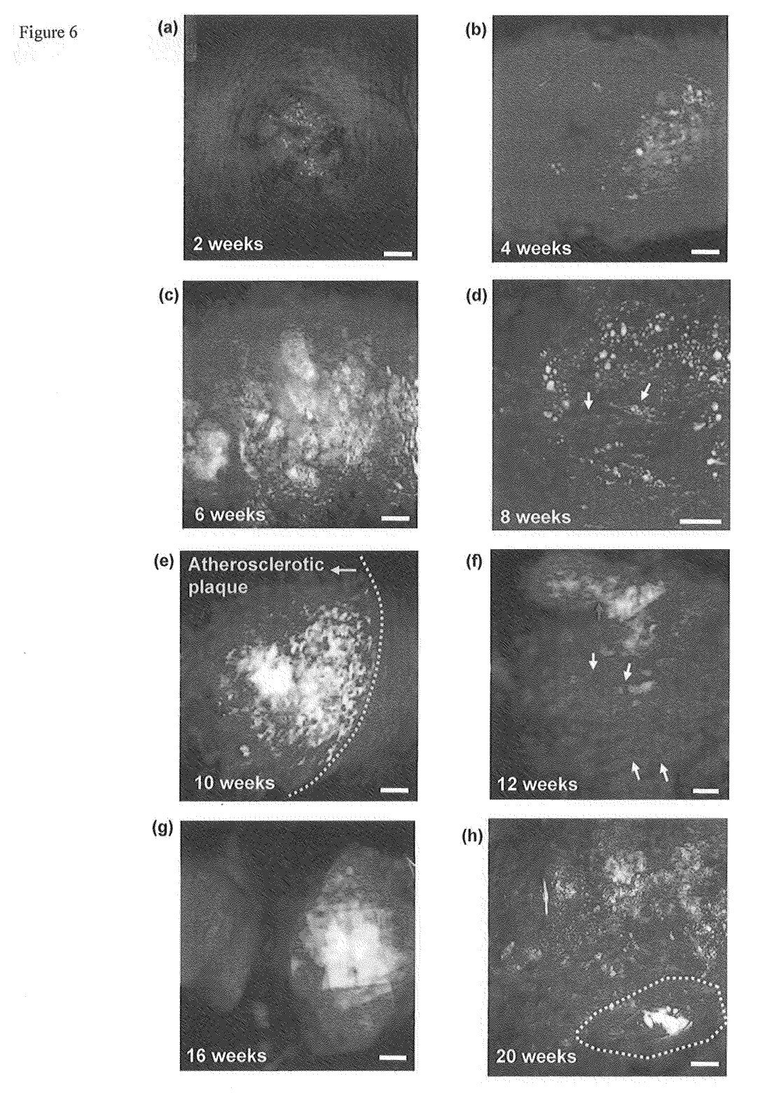

In the 2-week-old atherosclerosis mouse models, few of the imaged lipid droplets were bound to the extracellular matrix (ECM) (FIG. 6a). In the 4-week-old atherosclerosis mouse models, lipid droplets were observed only in the superficial intima (<10 μm in the penetration depth) and rearranged in the form of craters toward the medium below the ECM (FIG. 6b). At 6 weeks, the number of lipid droplets was significantly increased relative to the number present at 2 weeks (FIG. 6c). Particularly, extracellular lipid droplets were retained in the ECM up to 30 μm in the penetration depth at this time. Some intracellular lipid droplets were distributed in the form of typical cells with a dark void in the center, presumably a nucleus, suggesting that these structures were lipid-laden foam cells. At 8 weeks, the atherosclerotic lesions exhibited advanced pathological features, such as crystallized lipid structures (FIG. 6d). Foam cells were still imaged only in the superficial intima. However, the foam cells were structurally clearer than those at 6 weeks (the white arrow in FIG. 6d). Additionally, the entire volume of the necrotic core was measurable in the 3-D CARS imaging: 100 to 120 μmin diameter. In the 10-week-old atherosclerosis mouse model, the hemispherical shape of atherosclerotic lesions consists of foam cells and extracellular lipid deposits (FIG. 6e). At 12 weeks, lipid crystals were observed to penetrate into the vessel wall to the depth of 60 μm or greater (FIG. 6f). Some lipid droplets were found to be deposited on the well-defined multiple layers of plate-shaped crystallized lipids in the deep intima (blue arrows). However, foam cells were detected to remain still healthy (white arrows). At 16 weeks, the necrotic core had enlarged and projected toward the lumen. Its size had increased to approximately 250 μm in diameter (FIG. 6g), which was almost twice as large as that observed at 8 weeks. Interestingly, crystallized lipid layers were predominantly imaged while the number of foam cells was notably diminished, indicating the time point at which foam cells shifted to extracellular lipids. At 20 weeks, fibrous enlargement was imaged (FIG. 6h).

### EXPERIMENTAL EXAMPLE 3

### Identification of Characteristics of Atherosclerotic Plaques by CARS

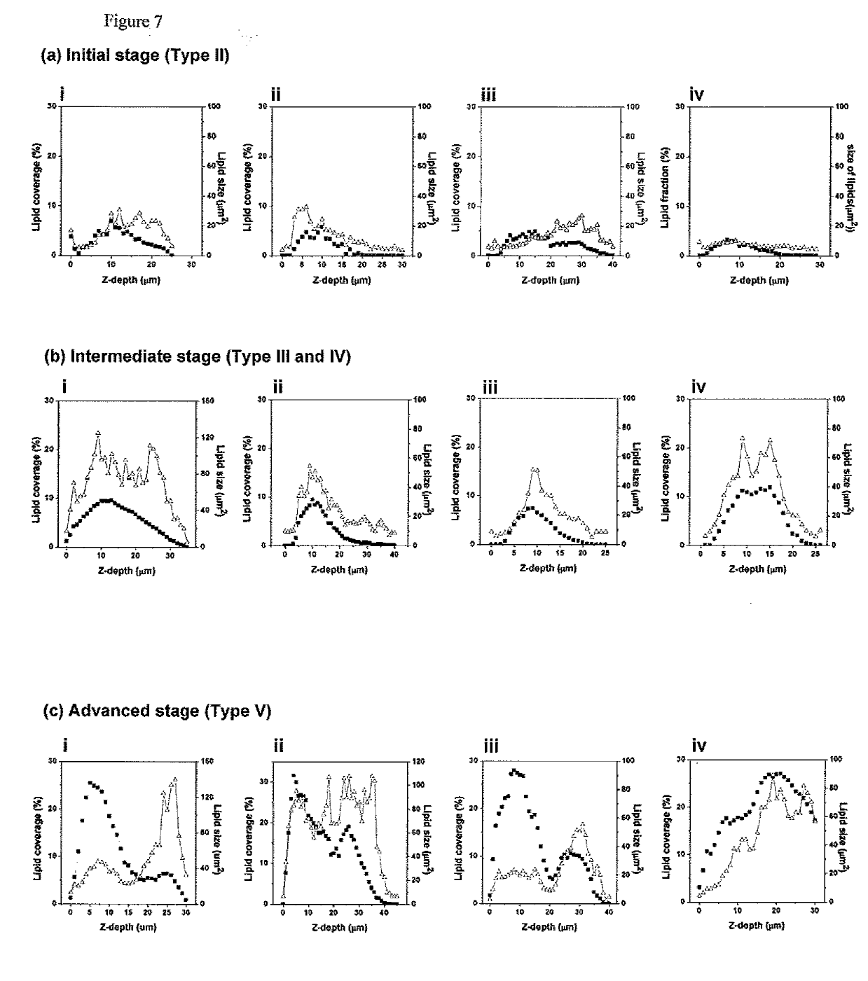

Using 3D CARS imaging, lipid distribution was quantified in three main stages (initial, intermediate and advanced stages: FIG. 7). The progression of atherosclerosis was analyzed in terms of the volume of lipid segments (calculated as 2D coverage in z-stack) and the size of the lipid structure.

The progression of atherosclerosis was analyzed by quantifying accumulated lipids at 3 stages depending on the period of high-fat diet consumption. During the initial stage (weeks 2-6, FIG. 7A i-iv), only a small amount of lipids is clearly represented in a small size. In the intermediate stage (weeks 8-12, FIG. 7b: i-iv), lipid deposits moved deep in the z-stack. Interestingly, their size was increased in the deep intima to form plate-shaped liquid crystals. In the advanced stage (week 16, FIG. 7c: i-iv), the lipids increased in both coverage and size. Atherosclerotic lipids penetrated to the depth of 30 μm, and even a single lipid structure with a size of as large as 90 μm² were directly detected, which is characteristic of significant atherosclerotic plaques.

In addition, as a result of the comparison of lipid distributions in i-iv of FIGS. 7a-7c using the 3D imaging capability of CARS for single atherosclerotic lesions, heterogeneity was found among the atherosclerotic plaques.

### EXPERIMENTAL EXAMPLE 4

### Chemical Profiling On-Site Analysis of Imaged Atherosclerotic Lipids Using Multiplex CARS

Chemical differences among various types of atherosclerotic lipids were analyzed on the basis of spectral patterns using multiplex CARS. Depending on the morphological differences of the en face images, the analyzed lipids were classified into four main categories, that is, extracellular and intracellular lipid droplets, and plate- and needle-shaped lipids.

The spectra of both extracellular lipid droplets in the ECM and intracellular lipid droplets from lipid-laden foam cells exhibited one main peak (2845 cm⁻¹) resonating at the symmetrical CH₂ vibration. The chemical profile of the plate-shaped lipid crystal, however, was significantly different from that of lipid droplets, because it exhibited 4 extra peaks at 2880, 2905, 2920 and 2950 cm⁻¹ on the CARS spectrum. The extra peaks were assigned as CH₂ asymmetrical, CH₃ symmetrical, and CH₃ asymmetrical vibrations, respectively. Conversely, the needle-shaped crystallized lipids showed weaker peaks at 2905, 2920 and 2950 cm⁻¹ as compared to the spectra of plate-shaped lipid crystals. The penetration depth of lipid-crystal structures was analyzed over a wide area. The resulting spectra were highly reproducible based on the appearance of the lipids, irrespective of their depth (n=187).

### INDUSTRIAL APPLICABILITY

Having the ability to selectively image lipids without damage attributable to staining, destruction or labeling, the system and the method of the present invention can diagnose the stage of progression of atherosclerosis and find useful applications in the medical instrument industry.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A system for diagnosing a pathological change of lipids in blood vessels, comprising:
a near infrared pulse laser unit for selectively illuminating Stokes beams, pump beams and probe beams to generate a combined laser beam, said Stokes beams, said pump beams and said probe beams being different in wavelength from one another;
a platform in which a sample is mounted, said sample being illuminated with the combined laser beam generated by the near-IR pulse laser unit;
a wideband multiplex CARS microspectrometer unit for collecting CARS signals generated from the sample to detect a spectrum;
an en face CARS image mode detection unit for collecting CARS signal generated from the sample to reconstruct a three-dimensional image; and
a dichroic mirror, located between the wideband multiplex CARS microspectrometer unit and the en face CARS image mode detection unit, for selectively transferring the CARS signal generated from the sample into each unit.

2. The system of claim 1, wherein the sample is an animal cardiovascular sample.

3. The system of claim 1, wherein the CARS signal ranges in bandwidth from 2700 to 3050 cm⁻¹.

4. The system of claim 1, wherein the CARS signal is collected at a rate of 1.0 s/frame, with a spatial resolution of 0.4 μm in a lateral plane and 1.3 μm along an axial direction.

5. The system of claim 1, wherein the dichroic mirror reflects wavelengths less than 1000 nm, but passes wavelength of 1000 nm or greater.

6. The system of claim 1, wherein the pathological change is an atherosclerotic plaque.

7. A method for diagnosing a non-destructive pathological change of lipid in blood vessels, comprising:
illuminating a Stoke beam and a pump beam on a sample to generate CARS (coherent anti-Stokes Raman scattering) lipid signal and measuring wavelength and intensity of the CARS signal;
constructing the signal as a three-dimensional image; and
analyzing structures of lipids from the image.

8. The method of claim 7, wherein the sample is an animal cardiovascular sample.

9. The method of claim 7, wherein the pathological change is an atherosclerotic plaque.

10. A method for diagnosing a non-destructive, pathological change of lipid in blood vessels, comprising:
illuminating a probe beam on a sample to generate CARS (coherent anti-Stokes Raman scattering) lipid signal and measuring wavelength and intensity of the CARS signal;
detecting the signal in a spectral pattern; and
analyzing structures of lipid from the spectral image

11. The method of claim 10, wherein the sample is an animal cardiovascular sample.

12. The system of claim 10, wherein the pathological change is an atherosclerotic plaque.
